(19) United States
(12) Patent Application Publication
(10) Pub. No.: US 2013/0185097 A1
(43) Pub. Date: Jul. 18, 2013

(54) MEDICAL SCORING SYSTEMS AND METHODS

(71) Applicant: The Board of Trustees of the Leland Stanford Junior University, Palo Alto, CA (US)

(72) Inventors: Suchi Saria, New York, NY (US); Anand Krishnakumar Rajani, Fresno, CA (US); Jeffrey Benjamin Gould, Berkeley, CA (US); Daphne Koller, Portola Valley, CA (US); Anna Asher Penn, Palo Alto, CA (US)

(73) Assignee: The Board of Trustees of the Leland Stanford Junior University, Palo Alto, CA (US)

(21) Appl. No.: 13/786,073

(22) Filed: Mar. 5, 2013

Related U.S. Application Data
(63) Continuation of application No. PCT/US2011/050562, filed on Sep. 6, 2011.
(60) Provisional application No. 61/380,680, filed on Sep. 7, 2010.

(51) Int. Cl. G06F 19/00

(52) U.S. Cl. CPC G06F 19/3431
USPC 705/3

(57) ABSTRACT

Systems and methods for generating a medical score are disclosed. In some embodiments, an accurate medical score is generated within a relatively short period of time. The medical score can be derived from observational data and/or physiological time-series data collected from a subject. In some embodiments, a scoring system accesses the data, and at least a portion of the data is used in the calculation of the medical score. In certain embodiments, health care providers can use the medical score to make early predictions of complications in intensive care unit patients.

### INCORPORATION BY REFERENCE TO ANY PRIORITY APPLICATIONS

Any and all applications for which a foreign or domestic priority claim is identified in the Application Data Sheet as filed with the present application are incorporated by reference under 37 CFR 1.57 and made a part of this specification.

### BACKGROUND

1. Field

This disclosure generally relates to systems and methods for predicting morbidity in medical patients.

2. Description of Related Art

Certain risk scoring techniques exist that may be used to assess the health of premature babies, including, for example, Score for Neonatal Acute Physiology II (SNAP-II), Score for Neonatal Acute Physiology Perinatal Extension II (SNAPPE-II), Clinical Risk Index for Babies (CRIB), and Revised Clinical Risk Index for Babies (CRIB-II). Existing risk scoring techniques suffer from various drawbacks.

### SUMMARY

At least some existing risk scoring techniques do not make use of a substantial amount of data that is available for patients being treated in an intensive care unit (ICU) or for babies being treated in a neonatal intensive care unit (NICU). For example, in a NICU, premature babies are typically continuously monitored for their heart rate, respiration, and blood oxygen levels. Some embodiments seek to improve on existing scoring systems by making use of physiological data that is captured over several hours after the birth of a pre-term infant (e.g., an infant with less than or equal to 34 weeks gestation and/or birth weight of less than or equal to 2000 grams). For example, a risk scoring system can use physiological time-series data collected during the first three hours after birth, during a three hour interval within 24 hours of birth, during a period of the first several hours after birth, during another suitable interval within 24 hours of birth, or during a combination of time periods.

Although time-series physiological data is routinely and/or automatically recorded in many intensive care units, techniques have not previously been developed to use a stable value (e.g., the average value or mean) and a characterization of dynamics (e.g., the variance) of such time-series physiological data for rapid, accurate morbidity prediction. Instead, some existing morbidity scoring systems and other medical scoring techniques have employed human observations, qualitative descriptors, data collected using invasive measurements or techniques, data collected using human intervention, or a combination thereof.

In some embodiments, available non-invasive, physiological time-series data is collected in the first few hours of a premature baby's life, e.g., first three hours of life. The time-series data may be collected or accessed digitally, for example, via wired or wireless communication networks. Observational data indicative of prenatal risk factors are also recorded, including gestational age and birth weight. In some embodiments, some, a substantial portion, substantially all, or all of the collected data is considered in the calculation of a medical score that accounts for subtle and multiple physiological indicators. By detecting and using subtle variability related patterns that arise in time-series physiological data, health care providers can make early predictions of complications in intensive care unit patients.

Certain embodiments use machine learning and pattern recognition algorithms to generate weightings used in the calculation of a probability score. Machine learning and pattern recognition algorithms can allow improvement or optimization of a scoring system in an automated, unbiased manner. The weightings can be determined from physiological data collected from individuals within a group of premature babies. Some embodiments provide a probability that an infant would be considered a high morbidity risk. In certain such embodiments, the probability for illness severity is calculated using a logistic function that aggregates individual risk features. Several recorded characteristics (e.g., physiological parameters, gestational age or weight) can be used to derive a numerical risk feature via nonlinear Bayesian modeling. At least some of the parameters of the logistic function can be machine-learned from a training data set derived from the group of premature babies.

Some embodiments allow for the setting of a threshold probability score in order to achieve desired sensitivity and specificity for the prediction of high risk of morbidity. The threshold may be user-defined or may be updated or determined automatically by the system. When compared to existing neonatal scoring systems (e.g., SNAP-II, SNAPPE-II, and CRIB), at least some embodiments provide greater sensitivity and/or specificity in predicting the risk of high morbidity.

In certain embodiments, the probability of an individual preterm infant's risk of severe morbidity is accurately and reliably estimated based at least in part on non-invasive measurements taken in the first hours of life. Individual risk prediction based at least in part on easily automated, rapid, non-invasive measures can offer opportunities for improved parental counseling, more precise resource allocation within hospitals, early recognition of a need to transfer a subject to a higher level of care, better prediction of a need for transfer to a higher level of care, or a combination of advantages. For example, certain such embodiments may be used to provide diagnostic or treatment regimens for the infant or assist in determining when the infant may safely be released from the NICU or the hospital. Thus, certain such embodiments advantageously may provide improved health care for the infant and/or reduced health care costs for the infant's parents or the hospital. Since certain embodiments of the scoring systems and methods described herein may be used with any type of human or animal subject, some or all of the foregoing advantages are not limited to use with preterm infants and can apply more generally.

Scoring systems and methods disclosed herein are flexible and easily applied to a range of prediction tasks, offering the ability to target risk scores to particular clinical needs. Certain embodiments can be implemented in intensive care situations, such as, for example, intensive care units (ICUs) where adult patients are treated, where continuous or continual monitoring is performed, such as in cardiac, burn, or other trauma situations. In such intensive care situations, copious patient data is typically collected in digital form. Accordingly, the techniques disclosed herein, including, for example, the machine learning methods and the development of a characteristic probability score, can be implemented to improve medical care and patient counseling, among other things.

Some embodiments provide a method for predicting morbidity of a premature infant using at least two noninvasive physiological properties. The method can include accessing from a computer storage medium a gestational age and a birth weight of the premature infant and accessing from a computer storage medium substantially continuous time-series data for two noninvasive physiological properties of the premature infant during a monitoring period of between about one hour and about 10 hours. Other suitable monitoring periods can be used, including, for example, monitoring periods that are less than or equal to about 24 hours. The time-series data can be collected without substantial human intervention during the monitoring period. The method can include computing a stable value and a characterization of dynamics of the time-series data for at least one of the two physiological properties. The stable value can be, for example, an average value or a mean of the time-series data or of a data set derived from the time-series data. The characterization of dynamics can be, for example, one or more measures of the variance of the time-series data or of a data set derived from the time-series data. The method can include determining, via execution of instructions on computer hardware, a morbidity risk factor for: (1) the gestational age of the premature infant, (2) the birth weight of the premature infant, and (3) each of the stable values and the characterizations of dynamics. The method can include weighting each of the morbidity risk factors using weightings learned from an optimization procedure optimized on a model group of premature infants. The optimization procedure can include any suitable procedure used to determine a fit of the risk factors to observed data from the model group, including, for example, least squares, maximum likelihood, posterior mode, or another procedure. The method can include aggregating each of the weighted morbidity risk factors to generate a predictive indicator of morbidity of the premature infant. In some embodiments, the predictive indicator is outputted to a front end module.

In certain embodiments, the two physiological properties include a heart rate of the infant and a respiratory rate of the infant. The method can include accessing from a computer storage medium substantially continuous time-series data for at least a third physiological property. The at least a third physiological property can be oxygen saturation of the premature infant.

In some embodiments, determining a morbidity risk factor for each of the stable values and the characterizations of dynamics includes comparing the stable values and the characterizations to a nonlinear probability function. The stable value of the time-series data can be the mean of the time-series data. The characterization of dynamics of the time-series data can be the variance.

In certain embodiments, computing a stable value and a characterization of dynamics of the time-series data for at least one of the two physiological properties includes receiving original time-series physiological data, computing a base signal by time-averaging the original physiological data, computing a residual signal by calculating a difference between the base signal and the original signal, and computing the variance of the base signal and the residual signal. In certain such embodiments, the mean of the base signal is computed. The base signal can be computed, for example, by time-averaging the original physiological data includes computing the base signal using a moving average window of 10 minutes. Any other technique for generating a smoothed or filtered base signal can be used.

A method for predicting morbidity can include accessing from a computer storage medium substantially continuous time-series data for at least a third physiological property of the premature infant collected during the monitoring period and computing a mean of the time-series data for the third physiological property. In some embodiments, a ratio is computed between a period of time when the third physiological property is below a threshold level and the monitoring period. A morbidity risk factor indicated by the ratio can be determined.

In some embodiments, a method for predicting morbidity includes accessing from a computer storage medium data collected using at least one invasive measurement of the premature infant. The predictive indicator and at least one other medical score can be used to assess the physical well being of the premature infant.

Certain embodiments provide a system for predicting morbidity of a subject using at least two noninvasive physiological properties. The system can include a front end module configured to provide a user interface for communicating a morbidity prediction to a health care provider, physical computer storage configured to store a gestational age and a birth weight of the subject, and substantially continuous time-series data for two noninvasive physiological properties of the subject during a monitoring period greater than or equal to about one hour, and a hardware processor in communication with the physical computer storage. The hardware processor can be configured to execute instructions configured to cause the hardware processor to access from the physical computer storage the gestational age and the birth weight of the subject, access from the physical computer storage the substantially continuous time-series data for at least two noninvasive physiological properties of the subject during a monitoring period greater than or equal to about one hour, compute one or more characterizations of the time-series data for each of the at least two noninvasive physiological properties, determine a morbidity risk factor for the gestational age, for the birth weight, and for each of the one or more characterizations of the time-series data, weight each morbidity risk factor using weightings learned from an optimization procedure optimized on a sample population, aggregate each of the weighted morbidity risk factors to generate a predictive indicator of morbidity of the premature infant, and output the predictive indicator to the front end module. The subject can be a patient, such as, for example, a premature infant or a patient in an intensive care unit. The sample population can be a model group of premature infants or another group relevant to the subject.

In some embodiments, the time-series data is collected for the at least two noninvasive physiological properties without substantial human intervention during the monitoring period. The monitoring period can be any suitable period, including, for example, periods greater than or equal to about one hour, greater than or equal to about three hours, less than or equal to about 24 hours, and/or less than or equal to about 10 hours.

Certain embodiments provide a method for creating a scoring system for a probability for illness severity of a subject using at least two noninvasive physiological properties. The method can include accessing from a computer storage medium observational data associated with each member of a model group, accessing from a computer storage medium substantially continuous time-series data for at least two noninvasive physiological properties of each member of the model group collected during a monitoring period greater than or equal to about one hour, computing observed values for each of the at least two physiological properties, wherein the observed values for the at least two physiological properties include one or more characterizations of the time-series data, dividing the model group into two or more sickness categories, and selecting a probability distribution for the observed values in each of the two or more sickness categories of the model group by using a maximum-likelihood estimation on a set of long-tailed probability distributions. The two or more sickness categories can include, for example, categories of high morbidity risk and low morbidity risk. Each selected probability distribution can provide a fit to the observed values for the subjects in each of the two or more sickness categories. A numerical risk feature for each observed value based on the selected probability distribution for the observed values in each of the two or more sickness categories can be determined via execution of instructions on computer hardware. A set of score parameters, including a weighting for each of the numerical risk features, can be determined via execution of instructions on computer hardware.

In some embodiments, a method for creating a scoring system includes accessing from a computer storage medium substantially continuous time-series data for at least a third noninvasive physiological property of each member of the model group collected during the monitoring period and computing at least one observed value from the time-series data for the third noninvasive physiological property. The at least one observed value can include a stable value of the time-series data for the at least a third noninvasive physiological property.

The score parameters can be determined by any suitable technique, such as, for example, a technique that includes maximizing the log likelihood of the observed values in the model group with a ridge penalty via execution of instructions on computer hardware. The members of the model group can be selected from a geographical region surrounding an institution wherein the subject will receive treatment or using other suitable criteria.

In certain embodiments, the set of long-tailed probability distributions includes at least one of an Exponential, Weibull, Log-Normal, Normal, or Gamma distribution. The observed values can include, for example, a mean, a residual, or a mean and a residual.

A probability P for illness severity of a subject can be determined, via execution of instructions on computer hardware, using a logistic function to aggregate numerical risk features f(vᵢ):

$$P ( HM \vert {v}_{1} , {v}_{2} , … , {v}_{n} ) = {( 1 + exp ( b + {w}_{0} * c + {\sum }_{i = 1}^{n} {w}_{i} * f ( {v}_{i} ) ) )}^{- 1} .$$

In this function, n is the number of numerical risk features, c is an a priori log-odds ratio, and b and w are score parameters learned from the model group for use in prospective risk prediction. Other techniques for aggregating risk features can also be used.

### BRIEF DESCRIPTION OF THE DRAWINGS

Some embodiments are depicted in the accompanying drawings for illustrative purposes, and should in no way be interpreted as limiting the scope of the inventions described herein. In addition, various features of different disclosed embodiments can be combined to form additional embodiments, which are part of this disclosure. Any feature or structure can be removed or omitted. Throughout the drawings, reference numbers may be reused to indicate correspondence between reference elements.

FIG. 1 is a block diagram illustrating an embodiment of a scoring system for predicting patient morbidity in an intensive care unit.

FIG. 2 is a block diagram illustrating an embodiment of a system for determining a score for intensive care unit patients.

FIG. 3 is a flowchart illustrating an example method for determining score parameters.

FIG. 4 is a flowchart illustrating an example method for determining a patient score.

FIG. 5 is a flowchart illustrating an example method for computing characterizations of noninvasive data.

FIG. 6 is a flowchart illustrating another example method for computing characterizations of noninvasive data.

FIG. 7 is a flowchart illustrating an example method for computing a probability of illness severity.

FIG. 8 is a receiver operating characteristic curve comparing the performance, in an embodiment, of a morbidity score to certain existing scoring systems.

FIG. 9 is a receiver operating characteristic curve comparing the performance, in an embodiment, of a morbidity score to a morbidity score that includes laboratory studies.

FIG. 10 is a receiver operating characteristic curve showing the performance, in an embodiment, of a morbidity score as it relates to predicting infection related complications.

FIG. 11 is a receiver operating characteristic curve showing the performance, in an embodiment, of a morbidity score as it relates to predicting major cardiopulmonary complications.

FIG. 12 are graphs illustrating the probability of high morbidity classification as expressed by a non-linear function and the learned weight for each parameter incorporated into a morbidity score in some embodiments.

FIGS. 13 and 14 are graphs demonstrating differing heart rate variability in two neonates.

FIGS. 15 and 16 are graphs demonstrating the distribution of residual heart rate variability (HRvarS) in infants of a study population.

### DETAILED DESCRIPTION

Although certain embodiments and examples are disclosed herein, inventive subject matter extends beyond the examples in the specifically disclosed embodiments to other alternative embodiments and/or uses, and to modifications and equivalents thereof. Thus, the scope of the claims appended hereto is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments; however, the order of description should not be construed to imply that these operations are order dependent. Additionally, the structures, systems, and/or devices described herein may be embodied as integrated components or as separate components. For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

### I. Overview

At least some existing medical scoring techniques do not make use of a substantial amount of data that is available for patients being treated in an intensive care unit (ICU) or for babies being treated in a neonatal intensive care unit (NICU). For example, in a NICU, premature babies are typically continuously monitored for their heart rate, respiration, and blood oxygen levels. Some embodiments seek to improve on existing scoring systems by making use of physiological data that is captured over several hours after the birth of a pre-term infant (e.g., an infant with less than or equal to 34 weeks gestation and/or birth weight of less than or equal to 2000 grams). For example, a risk scoring system for premature babies can use physiological time-series data collected during the first three hours after birth; during a three hour interval within 24 hours of birth; during an interval less than or equal to about 24 hours; during about a half hour, one hour, two hour, three hour, four hour, five hour, six hour, seven hour, eight hour, nine hour, or ten hour interval; during an interval of between about one hour and about ten hours; during a period of the first hour or hours after birth; during another suitable interval within a short time of birth; during an interval between any of the times listed in the paragraph, or during a combination of time periods. The physiological time-series data can be collected during a period of between about 1% and 100% of the infant's age, such as, for example, about 1%, 5%, 10%, 12.5%, 15%, 20%, 30%, 50%, 75%, 90%, or 100% of the infant's age, or during a period between any of the preceding values.

Although time-series physiological data is routinely and/or automatically recorded in many intensive care units, techniques have not previously been developed to use the stable value and a characterization of dynamics of such time-series physiological data for rapid, accurate morbidity prediction. Instead, existing morbidity scoring systems have employed subjective human observations, qualitative descriptors, data collected using invasive techniques, data collected using human intervention, or a combination thereof. In some embodiments, a morbidity scoring system uses physiological time-series data recorded without substantial human intervention. For example, a morbidity scoring system can access from a computer storage medium substantially continuous time-series data for one or more physiological properties. In certain embodiments, the morbidity scoring system also uses some data collected at least in part with human intervention, such as, for example, gestational age and birth weight.

In some embodiments, available non-invasive, physiological time-series data is digitally collected in the first few hours of a premature baby's life, e.g., first three hours of life. Observational data indicative of prenatal risk factors are also recorded, including gestational age and birth weight. In some embodiments, some, a substantial portion, substantially all, or all of the collected data is used in the calculation of a morbidity score that accounts for subtle and multiple physiological indicators.

Certain embodiments use machine learning and pattern recognition algorithms to generate weightings used in the calculation of a probability score. For example, the weightings can be determined from physiological data collected from individuals within a group of premature babies. Some embodiments provide a probability that an infant would be considered a high morbidity risk. In certain such embodiments, the probability for illness severity is calculated using a logistic function that aggregates individual risk features. Several recorded characteristics (e.g., physiological parameter, gestational age or weight) are used to derive a numerical risk feature via nonlinear Bayesian modeling. At least some of the parameters of the logistic function can be machine-learned from a training data set derived from the group of premature babies.

Some embodiments allow for the setting of a threshold probability score in order to achieve desired sensitivity and/or specificity for the prediction of high risk of morbidity. The threshold may be user-defined or may be updated or determined automatically by the system. When compared to existing neonatal scoring systems (e.g., SNAP-II, SNAPPE-II, and CRIB), at least some embodiments provide greater sensitivity and specificity in predicting the risk of high morbidity.

In certain embodiments, the probability of an individual preterm infant's risk of severe morbidity is accurately and reliably estimated based at least in part on non-invasive measurements taken in the first hours of life. Individual risk prediction based at least in part on easily automated, rapid, non-invasive measures can offer opportunities for improved parental counseling and more precise resource allocation. For example, certain such embodiments may be used to provide diagnostic or treatment regimens for the infant or assist in determining when the infant may safely be released from the NICU or the hospital. Thus, certain such embodiments advantageously may provide improved health care for the infant and/or reduced health care costs for the infant's parents or the hospital. Since certain embodiments of the scoring systems and methods described herein may be used with any type of human or animal subject, some or all of the foregoing advantages are not limited to use with preterm infants and can apply more generally.

Scoring systems and methods disclosed herein are flexible and easily applied to a range of prediction tasks, offering the ability to target risk scores to particular clinical needs. Certain embodiments can be implemented in intensive care situations, such as, for example, intensive care units where adult patients are treated, where continuous or continual monitoring is performed, such as in cardiac, burn, or other trauma situations. In such intensive care situations, copious patient data is typically collected in digital form. Accordingly, the techniques disclosed herein, including, for example, the machine learning methods and the development of a characteristic probability score, can be implemented to improve medical care and patient counseling, among other things.

### II. Example Scoring System Architectures

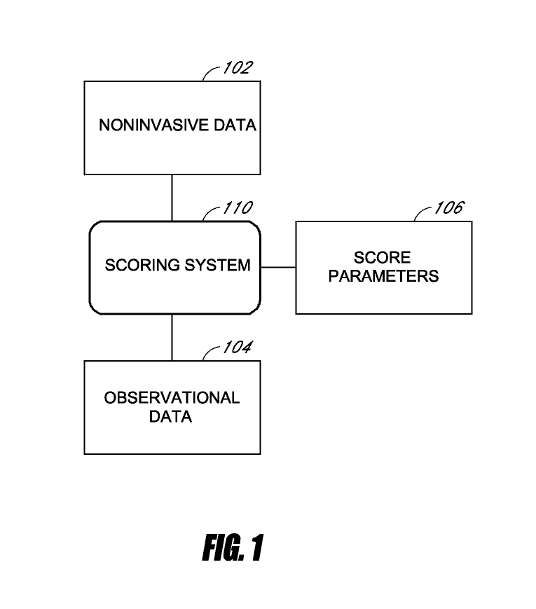

FIG. 1 is a block diagram schematically illustrating an embodiment of a system 110 for generating a medical score for a patient. In some embodiments, the scoring system 110 is configured to generate a score for predicting the morbidity of the patient within a relatively short period of time, such as, for example, a period of time less than or equal to about 24 hours, a period of time less than or equal to about 10 hours, between about 1 hour and about 10 hours, between about 2 hours and 4 hours, equal to about 3 hours, or less than or equal to about 3 hours. The scoring system 110 can include or be connected (wired or wirelessly) to sources of patient data 102, 104 and a source of other data 106 that is used to calculate a medical score.

Patient data can include noninvasive data 102 and observational data 104. Noninvasive data 102 includes data that is collected without substantial human intervention. Examples of noninvasive data 102 include heart rate data, respiration data, bloodstream oxygen saturation data, time-series physiological parameters, data that is recorded by a monitoring device, data that is produced by one or more sensors that are not introduced into the body, other types of data collected automatically without introduction of instruments into the body, or a combination of data. Observational data 104 includes data that is collected with at least some human assistance. Examples of observational data 104 can include body weight, age, twin or higher order multiple status, gestation age, sex, skin color, race, ancestry, parental ages, residence, geographical location (of patient birth or of the ICU providing treatment), pregnancy complications, placental or amniotic fluid pathology data, other types of data collected at least in part by humans, or a combination of data.

Other data used by the scoring system 110 can include score parameters 106. Score parameters 106 can include non-patient specific information that is used to produce a useful medical score. Examples of score parameters 106 can include morbidity risk factors, logistic functions, numerical risk features, weightings, model group data, calibration factors, qualification factors, statistical factors, other types of data, or a combination of data. A scoring system 110 can use one, a few, or many types of score parameters 106 to generate the medical score. The scoring system 110 can be connected to data sources directly, indirectly, through a network, through the Internet, in another suitable way, or through a combination of connections.

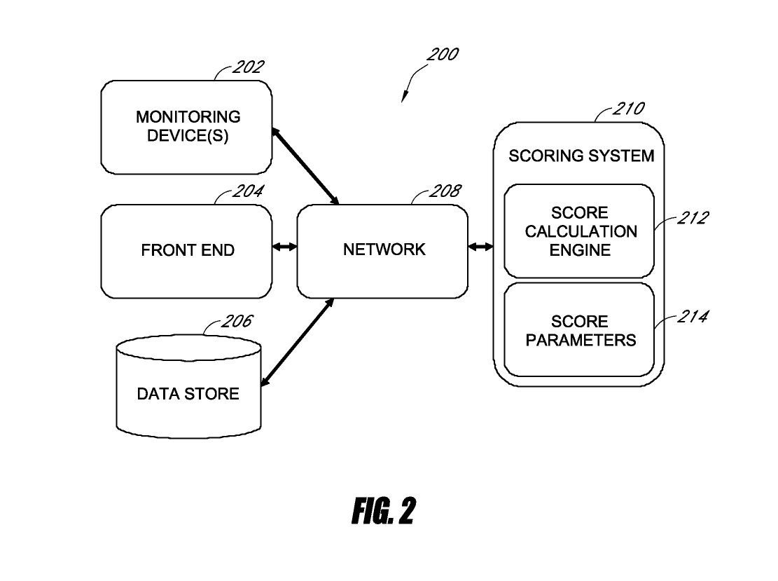

FIG. 2 is a schematic block diagram of an example system 200 for generating a medical score. The system 200 includes a scoring system 210 that can continuously or intermittently connect to, access, or communicate with one or more monitoring devices 202, a front end 204, and a data store 206. The one or more monitoring devices 202 can be configured to collect substantially continuous time-series physiological data from an ICU patient. Examples of monitoring devices include heart rate monitors, respiration monitors, oxygen saturation sensors, and devices that combine two or more monitoring functions in a single device.

The front end 204 provides a user interface for receiving data or commands from a health care provider and/or for communicating information, such as, for example, a medical score, to the health care provider. The data store 206 can maintain a record of patient data, medical scores, physiological data, measurements, time-series data, other medical data, or a combination of different types of data. The one or more monitoring devices 202, the front end 204, the data store 206, and the scoring system can connect to one another through a network 208. The network 208 can include a local area network, a wide area network, a wired network, a wireless network, a local bus, or any combination thereof. In some embodiments, one or more components of the system 200 connect another component of the system 200 over the Internet. The scoring system 210 can include an API or any other suitable interface for interacting with other data systems and with health care providers. In some embodiments, the scoring system 210 is integrated into one or more monitoring devices 202. In certain embodiments, the front end 204 is made available to a health care provider via a desktop computer, a notebook computer, a tablet computer, a handheld device, a monitoring device, a mobile telephone, or another suitable device.

The scoring system 210 shown in FIG. 2 includes a score calculation engine 212 and score parameters 214. The score calculation engine 212 can be configured to receive or access patient data from one or more data sources (e.g., the monitoring devices, the front end, and the data store) connected to the scoring system 210. The score calculation engine 212 determines a probability of illness severity in the ICU patient using the patient data and one or more score parameters 214. The probability of illness severity can be based on a model that associates the patient data with one or more morbidity risk factors or other risk factors. The score parameters 214 can provide the weight assigned to a numerical risk feature or morbidity risk factor associated with each type of patient data that is used in the model.

The scoring system 210 can include or be implemented with one or more physical computing devices, one or more of which can have a processor, memory, storage, a network interface, other computing device components, or a combination of components.

### III. Example Embodiments of Scoring Methods

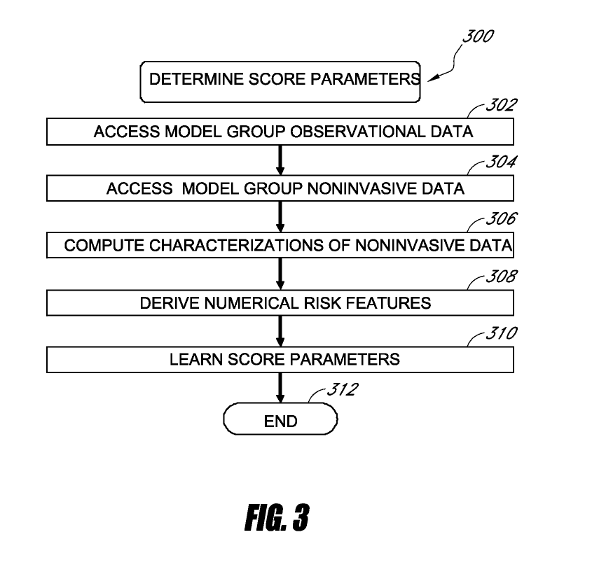

FIGS. 3-7 illustrate example methods of generating a medical score that can be computed using a scoring system 110, 210 such as those shown in FIGS. 1 and 2. The methods can be implemented by one or more modules associated with the scoring system 110, 210 or other components of the system 200.

FIG. 3 illustrates a method 300, according to some embodiments, for determining score parameters that can be used to weight morbidity risk factors or other risk factors in the calculation of a medical score. The score parameters can be derived by selecting a model group that is representative of a desired population. For example, the model group for a premature infant morbidity score might include a group of premature infants who meet one or more classification criteria. The classification criteria can include, for example, birth weight and/or gestation age. As another example, the model group for a premature infant morbidity score might include a group of premature infants born in the region where the scoring system is intended to be used. Because score parameters may vary by geographic region and/or other demographic factors, different institutions using the scoring system might employ different score parameters. In some embodiments, a scoring system includes a user interface for selecting a model group from a large set of group data. For example, the user interface can be used to filter the large set of group data by one or more demographic factors of the patient (or the patient's relatives), e.g., location, gestational age, birth weight, age of mother, age of father, gender, race, nationality, diet, education, ethnicity, and so forth.

At 302, observational data is accessed that was collected from individuals in the model group. Observational data can include at least some data that is not automatically collected by a monitoring device, such as, for example, gestational age and birth weight. The collecting of observational data can be performed manually (e.g., by receiving information from the patient or from a person who knows the patient) or can be at least partially automated using one or more devices or processes. Embodiments of the systems and methods described herein can access the model group observational data from a monitoring device, from a hospital information network, from a data repository, or from a wired or wireless network. In some such embodiments, a hardware computing device accesses the data from a memory (volatile or nonvolatile) that stores the data.

At 304, noninvasive data is accessed that was collected from individuals in the model group. Noninvasive data can include at least some data that is automatically collected by a monitoring device, such as, for example, heart rate, respiration rate, and oxygen saturation. Noninvasive data can be collected by automatic processes using one or more sensors connected to a monitoring device that digitizes sensor information. The monitoring device may communicate noninvasive data as a time-series physiological property measurement. The noninvasive data can also be accessed from a data source, such as, for example, a hospital information system, a patient data server, an electronic medical records system, another suitable data source, or a combination of data sources. Embodiments of the systems and methods described herein can access the model group noninvasive data from a monitoring device, from a hospital information network, from a data repository, or from a wired or wireless network. In some such embodiments, a hardware computing device accesses the data from a memory (volatile or nonvolatile) that stores the data.

At 306, one or more characterizations of the noninvasive data are computed. The characterizations can be used to derive one or more values that can fit into a model for generating a medical score. Examples of characterizations include a stable value, an average value, a mean, a characterization of dynamics, a variance, a time interval of when a physiological parameter falls within a desired range, a time interval of when a physiological parameter falls outside a desired range, a ratio of time intervals, another value that characterizes the data, or a combination of values. The original noninvasive data can be substantially continuous time-series data for a physiological parameter or another suitable measurement. The characterizations can be computed from the original data, smoothed data, residual data, base data, filtered data, time-averaged data, transformed data, or a combination of data representations.

At 308, numerical risk features based at least in part on the characterizations of noninvasive data and observational data are calculated. The numerical risk features can associate prospective patient data with one or more morbidity risk factors or other risk factors. In some embodiments, one or more continuous-valued risk factors, such as, for example, physiological measurements, are integrated into a risk model. For example, normal ranges for the physiological measurements can be defined. A metric can be used to characterize whether or how often the physiological measurements are inside the normal ranges or outside the normal ranges. As another example, a particular representation of the physiological measurements can be predetermined. The particular representation can include the feature itself, a quadratic transformation of the feature, a logarithmic transformation of the feature, another representation of the feature, or a combination of representations. Numerical risk features can be derived by comparing the representations to one or more ranges, analyzing the representations for trends, analyzing the representations for patterns, or by performing other suitable analyses.

In certain embodiments, numerical risk features are derived using a Bayesian modeling algorithm. Bayesian modeling can be used to determine one or more nonlinear relationships between risk factors and outcomes and can account for great variation in the behavior of a factor among various sickness categories. The model group can be separated into two or more sickness categories. Sickness categories can be based on broad classifications of wellness or sickness (e.g., low morbidity and high morbidity) and/or based on specific sicknesses or disease types (e.g., infection, cardiopulmonary complications, and so forth). For each characterization or risk factor, a distribution of observed values for model group members in each sickness category can be learned. For example, a particular model for each sickness category can be selected using maximum-likelihood estimation from a set of long-tailed probability distributions (such as, for example, Exponential, Weibull, Log-Normal, Normal, and Gamma). The probability distribution that provides the best fit to the data for each category can be selected. In some embodiments, the numerical risk features are the log-odds ratios of risk implied by each characterization (e.g., risk factor).

At 310, score parameters are learned. Different score parameters can be used for different demographic groups of subjects, or a single set of score parameters can be used for all subjects. In some embodiments, the score parameters are determined by maximizing the log likelihood of the observed data from the model group. A ridge penalty can be used to control model complexity and/or prevent over-fitting of observed data. For example, the ridge penalty can be selected to reduce spurious data dependence by enabling automatic factor selection to control model parsimony and prevent over-fitting. At 312, after the score parameters are learned, the scoring system can be used in an ICU to prospectively predict illness severity in subjects.

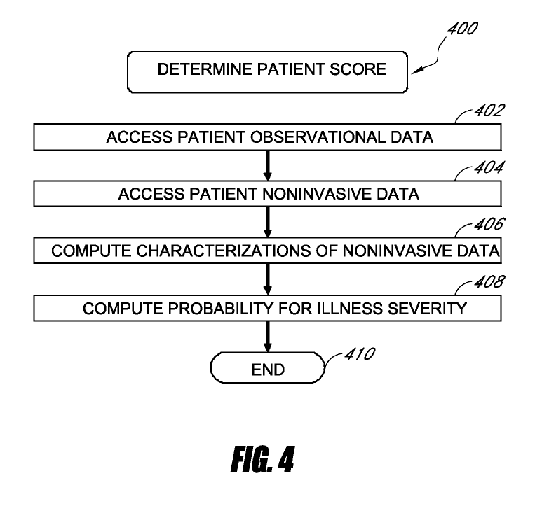

FIG. 4 illustrates a method 400, according to some embodiments, for determining a score for a patient being treated in an ICU. The method 400 can use the numerical risk features and score parameters derived using one of the techniques described herein, derived using a modification of the techniques described herein, or derived using another suitable technique.

At 402, observational data for the patient is accessed. Observational data can include at least some data that is not automatically collected by a monitoring device, such as, for example, gestational age and birth weight. The collecting of observational data can be performed manually (e.g., by receiving information from the patient or from a person who knows the patient) or can be at least partially automated using one or more devices or processes. Embodiments of the systems and methods described herein can access the patient observational data from a monitoring device, from a hospital information network, from a data repository, or from a wired or wireless network. In some such embodiments, a hardware computing device accesses the data from a memory (volatile or nonvolatile) that stores the data.

At 404, noninvasive data is accessed, which was collected from the patient. Noninvasive data can include at least some data that is automatically collected by a monitoring device, such as, for example, heart rate, respiration rate, and oxygen saturation. Noninvasive data can be collected by automatic processes using one or more sensors connected to a monitoring device that digitizes sensor information. The monitoring device may communicate noninvasive data as a time-series physiological property measurement. The noninvasive data can also be accessed from a data source, such as, for example, a hospital information system, a patient data server, an electronic medical records system, another suitable data source, or a combination of data sources. In some embodiments, at least two noninvasive physiological parameters are collected. In certain embodiments, at least three noninvasive physiological parameters are collected. Embodiments of the systems and methods described herein can access the patient noninvasive data from a monitoring device, from a hospital information network, from a data repository, or from a wired or wireless network. In some such embodiments, a hardware computing device accesses the data from a memory (volatile or nonvolatile) that stores the data.

At 406, one or more characterizations of the noninvasive data are computed. The characterizations can be used to derive one or more values that can fit into a model for generating a medical score. Examples of characterizations include a stable value, an average value, a mean, a characterization of dynamics, a variance, a time interval of when a physiological parameter falls within a desired range, a time interval of when a physiological parameter falls outside a desired range, a ratio of time intervals, another value that characterizes the data, or a combination of values. The original noninvasive data can be substantially continuous time-series data for a physiological parameter or another suitable measurement. The characterizations can be computed from the original data, smoothed data, residual data, base data, filtered data, time-averaged data, transformed data, or a combination of data representations. In some embodiments, the patient data is compared to data collected from a baseline group of one or more other subjects. One or more characterizations can be computed to establish the differences or similarities between data for the patient, whose illness severity may not be well known, and data from the baseline group. In certain embodiments, the illness severity of subjects in the baseline group is known. In certain embodiments, the subjects in the baseline group are healthy.

At 408, a probability for illness severity is computed using risk features derived from the one or more characterizations of the noninvasive data and the observational data and score parameters. The score parameters can be used to weight the risk features indicated by the noninvasive and observational data. The weighted individual risk features can be aggregated by using a logistic function. For example, the logistic function can take the form of P(x)=(1+exp(−x))⁻¹, where x corresponds to a weighted representation of the individual risk features. Suitable variations of the logistic function may also be used to aggregate the risk features. At 410, after the probability for illness severity is computed, the probability can be output to a front end or otherwise delivered to a health care provider as a medical score.

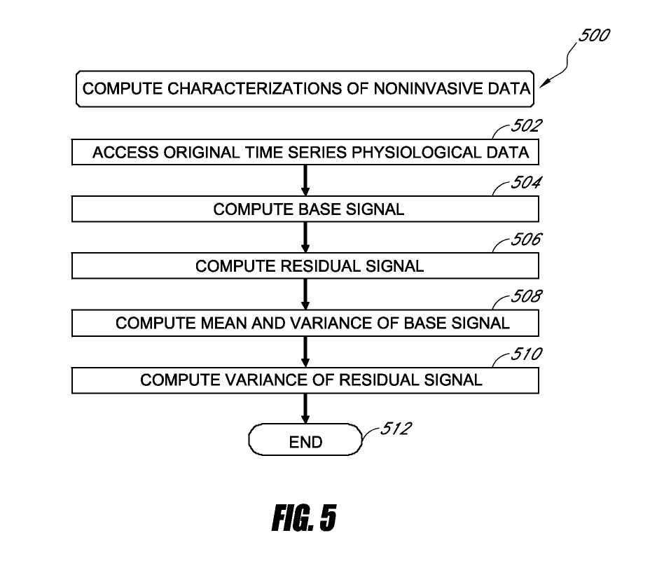

FIG. 5 illustrates a method 500, according to some embodiments, for computing characterizations of noninvasive physiological parameters. The method 500 can be used to prepare at least some types of physiological parameters to be used as risk factors in a logistic function. In some embodiments, the method 500 illustrated in FIG. 5 is used to characterize heart rate and respiratory rate signals.

At 502, original time series physiological data is accessed from one or more data sources. The data can be accessed from any suitable source, such as, for example, one or more monitoring devices, a front end module, a data store, a memory, or a combination of sources. In some embodiments, the time series physiological data includes heart rate, respiratory rate, and oxygen saturation data. Other physiological data can also be collected, if such data is used to generate a desired medical score.

At 504, a base signal is computed from the original time series data. In certain embodiments, the base signal is a smoothed version of the original data. The base signal can show long term trends in the original data by averaging data over a window of time. In some embodiments, the base signal is computing using a moving average window of several minutes, greater than or equal to about one minute, two minutes, three minutes, four minutes, five minutes, six minutes, seven minutes, eight minutes, nine minutes, 10 minutes, 15 minutes, 20 minutes, 25 minutes, 30 minutes, less than or equal to about 30 minutes, between about five minutes and about 20 minutes, or between any of the other values listed in this paragraph. In certain embodiments, the base signal is computed by filtering the original data. Any other suitable technique can be used to generate a smoothed base signal.

At 506, a residual signal is computed by taking the difference between the original signal and the base signal. In some embodiments, the residual signal characterizes short-term variability in the original data. Such short-term variability may be linked, for example, to sympathetic function.

At 508, one or more characterizations of the base signal are computed. The characterizations of the base signal can result in any risk factors that are used to generate a desired medical score. Examples of characterizations include a stable value, a mean, a characterization of dynamics of the base signal, a residual, and so forth. In some embodiments, the base signal mean and the base signal variance are computed. In some embodiments, the base signal mean and the base signal variance are computed for one or more physiological properties, and only the base signal mean or the base signal variance is computed for one or more other physiological properties.

At 510, one or more characterizations of the residual signal are computed. The characterizations of the residual signal can result in any risk factors that are used to generate the desired medical score. In certain embodiments, the residual signal variance is computed. In some embodiments, the residual signal mean need not be computed. In some embodiments, the residual signal variance is computed without computing the residual signal mean. At 512, after the characterizations of at least some noninvasive data are computed, the characterizations can be used as risk factors to calculate individual numerical risk features.

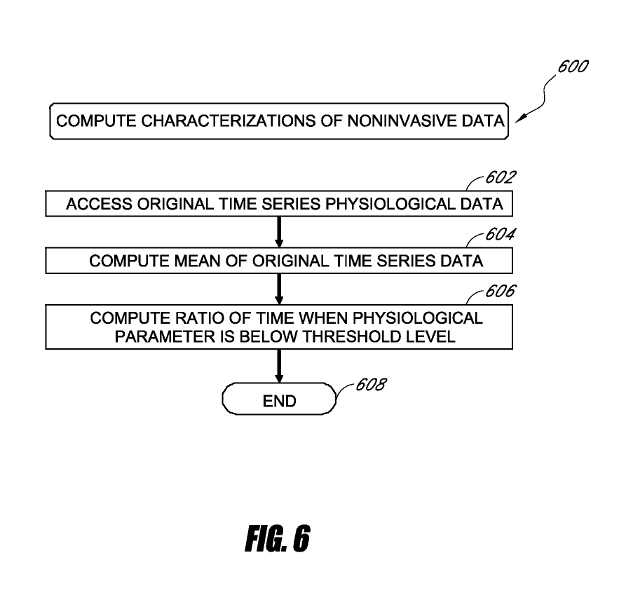

FIG. 6 illustrates another method 600, according to some embodiments, for computing characterizations of noninvasive physiological parameters. The method 600 can be used to prepare at least some types of physiological parameters for use as risk factors in a logistic function. In some embodiments, the method 600 illustrated in FIG. 6 is used to characterize oxygen saturation signals. The method 600 illustrated in FIG. 6 can be used in combination with the method 500 illustrated in FIG. 5. Other characterizations can be used to derive risk factors to achieve any desired numerical risk features.

At 602, original time series physiological data is accessed from one or more data sources. The data can be accessed from any suitable source, such as, for example, one or more monitoring devices, a front end module, a data store, or a combination of sources. In some embodiments, the time series physiological data includes heart rate, respiratory rate, and oxygen saturation data. Other physiological data can also be collected, if such data is used to generate a desired medical score.

At 604, a stable value is computed from the original time series data. In some embodiments, the stable value is the mean.

At 606, a ratio between a period of time when the original data is outside a target range and the domain of the time series data is computed. In some embodiments, the domain of the time series data corresponds to a monitoring period. The target range can be bounded by an upper threshold, a lower threshold, or a combination of upper and lower thresholds. In some embodiments, a ratio of time in hypoxia to time in normoxia is computed. In certain embodiments, a ratio of time in hypoxia to the monitoring period is computed. At 608, after the one or more characterizations of at least some noninvasive data are computed, the characterizations can be used as risk factors to calculate individual numerical risk features.

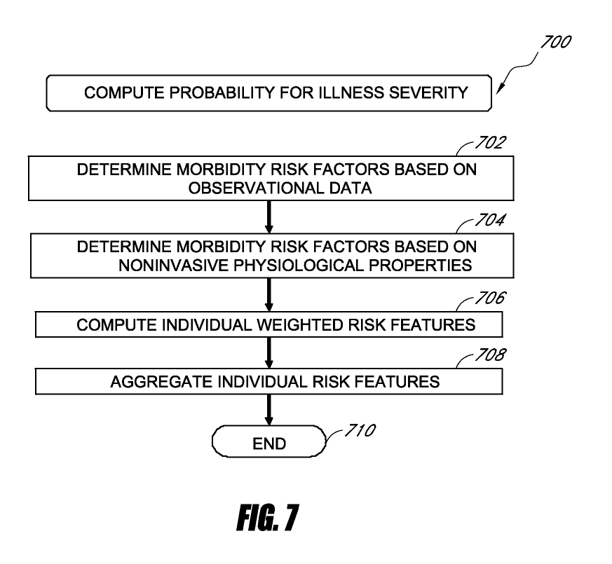

FIG. 7 illustrates a method 700, according to some embodiments, for computing a probability for illness severity. The method 700 can be used to generate a medical score from one or more risk factors. In some embodiments, the medical score is calculated using a combination of observed values for noninvasive physiological properties and observational data.

At 702, one or more morbidity risk factors are derived from observational data. In some embodiments, other numerical risk features can be derived from the observational data, in addition to or as an alternative to morbidity risk factors, depending on what risk features are used in the desired medical score. In certain embodiments where a morbidity score for a preterm infant is computed, morbidity risk factors are determined based on the gestational age and body weight of the infant at birth.

At 704, one or more morbidity risk factors are derived from measurements of noninvasive physiological properties. The risk factors can include one or more characterizations of time-series data, as disclosed herein. In addition to morbidity risk factors, other numerical risk features can be derived from the measurements of noninvasive physiological properties, depending on what risk features are used in the desired medical score. In certain embodiments where a morbidity score for a preterm infant is computed, morbidity risk factors are determined based on characterizations of the heart rate, respiration rate, and oxygen saturation time-series data of the infant within the first several hours after birth.

At 706, the risk features are weighted according to the score parameters derived from a model group. The score parameters may vary according to one or more demographic criteria, as disclosed herein.

At 708, a probability P for illness severity of a subject is determined In some embodiments, the probability P is determined using a logistic function to aggregate individual numerical risk features. For example, the following logistic function can be used to aggregate risk features f(vᵢ) to determine a probability of high morbidity (see also Eqn. (1), below):

$$P ( HM \vert {v}_{1} , {v}_{2} , … , {v}_{n} ) = {( 1 + exp ( b + {w}_{0} * c + {\sum }_{i = 1}^{n} {w}_{i} * f ( {v}_{i} ) ) )}^{- 1} ,$$

where n is the number of numerical risk features, c is the a priori log-odds ratio, and b and w are score parameters learned from the model group for use in prospective risk prediction. Another suitable logistic function can be used. The probability P can be determined via execution of instructions by a computer system comprising computer hardware.

At 710, after the probability for illness severity is determined, it can be outputted to a front end module or otherwise communicated to a health care provider.

### IV. Example Scoring System

The following describes examples of certain methods disclosed herein as applied to actual data obtained for preterm infants. The following examples are intended to be illustrative and are not intended to be limiting.

In the following examples, physiological time-series data was captured electronically for preterm infants (≦34 weeks gestation, birth weight ≦2000 grams). Physiological parameters were extracted and integrated using machine learning methods to produce a probability score for illness severity based on data from only the first 3 hours of life. In certain places of this disclosure and the accompanying figures, an example probability score for illness severity in accordance with some embodiments is shown and described. This disclosure is not limited to a particular implementation of a probability score. Modifications of, additions to, and deletions of physiological parameters disclosed herein can be made in order to produce a score for any desired purpose. In addition, the parameters, weightings and logistic functions used may vary among different diseases, population segments, and geographic regions. This disclosure provides techniques for identifying appropriate models for obtaining scores for a variety of different clinical purposes.

An example score parameter determination was validated on 138 infants using the leave-one-out method. In this example, the scoring system was designed to prospectively identify infants at risk of severe short- and long-term morbidity. The scoring system provided high-accuracy prediction of overall morbidity (e.g., 86% sensitive at 96% specificity) or specific complications (e.g., infection: 90% at 100%, cardiopulmonary: 96% at 100%), significantly higher than previously reported neonatal scoring systems such as SNAP, SNAPPE-II, CRIB. In this example, physiological signals, particularly short-term variability in respiratory and heart rate, contributed more to morbidity prediction than invasive laboratory studies. The example scoring system exhibited high risk stratification performance for many types of morbidity.

### A. Physiologic Parameters in Preterm Infants

Established perinatal risk factors, including gestational age and birth weight, and invasive laboratory measurements, such as blood gas analysis, have been incorporated into currently used algorithms for mortality risk assessment of preterm infants. But these algorithms have not been designed to predict an individual neonate's risk of major morbidities. Gestational age and birth weight are highly predictive of death or disability. But gestational age and birth weight do not estimate individual illness severity or morbidity risk.

Early, accurate prediction of a neonate's morbidity risk is of significant clinical value by allowing real-time changes in medical management Improved neonatal risk stratification could also inform decisions regarding aggressive use of intensive care, need for transport to tertiary centers and resource allocation, potentially reducing the currently estimated $26 billion per year in United States health care costs resulting from preterm birth.

To achieve improved accuracy and speed of individual morbidity prediction for preterm neonates, some embodiments provide a probability score based on physiological data obtained non-invasively after birth plus gestational age and birth weight. Changes in heart rate characteristics or variability can suggest impending illness and death across a range of clinical scenarios, from sepsis in intensive care patients to fetal intolerance of labor. However, the predictive accuracy of a single parameter may be limited.

Intensive care providers view multiple physiological signals in real-time to assess health, but significant patterns may be subtle and multiple physiological parameters have not been integrated systematically for preterm neonatal morbidity prediction.

In some embodiments, a scoring system uses multiple complex physiological signals to determine a morbidity prediction. A scoring system can be directly or indirectly linked to a digital medical records system, thereby allowing the linking of real-time physiological signals with later outcomes. The determination of scoring parameters for the scoring system can be assisted by machine learning and pattern recognition algorithms. In some embodiments, machine learning and pattern recognition algorithms are used to determine the physiological parameters used in the scoring system, the morbidity risks associated with those physiological parameters, and/or appropriate weightings of the morbidity risks in an overall morbidity score.

An example scoring system embodiment was evaluated for predicting overall morbidity and mortality, specific risk for infection or cardiovascular and pulmonary complications, and a combination of complications associated with poor long-term neurodevelopment as compared to standard scoring systems in a preterm neonatal cohort.

The example scoring system embodiment was evaluated on a study population of inborn infants admitted to the Neonatal Intensive Care Unit of Lucile Packard Children's Hospital in Palo Alto, Calif. Infants born between March 2008 and March 2009 were eligible for enrollment. A total of 145 preterm infants met the following inclusion criteria: gestational age ≦34 completed weeks, birth weight ≦2000 grams, and availability of cardiorespiratory (CR) monitor data within the first three hours of birth. Seven infants found to have major malformations were subsequently excluded.

Following enrollment, a subset of patients (n=12) were used to develop physiologic data processing methods. A framework was then developed that processed these physiological parameters using non-linear models, used multivariate logistic regression with regularization to select relevant features and combined them to produce a predictive scoring system based on the physiological features plus birth weight and gestational age. The predictive ability of the scoring system and methods were tested using the leave-one-out method on a larger dataset of 138 infants to prospectively identify infants at high risk of severe complications.

As part of the evaluation of the scoring system and methods, electronic medical records, imaging studies, and laboratory values were reviewed by pediatric nurses and verified by a physician. Significant illnesses during the hospitalization were recorded. Morbidities were identified using previously described criteria: bronchopulmonary dysplasia (BPD); retinopathy of prematurity (ROP); necrotizing enterocolitis (NEC); and intraventricular hemorrhage (IVH).

For IVH and ROP, the highest unilateral grade or stage was recorded, respectively. Acute hemodynamic instability was also noted: hypotension (defined as a mean arterial blood pressure less than gestational age or poor perfusion) requiring >=3 days of pressor support or adrenal insufficiency requiring hydrocortisone.

Patients were classified as high morbidity (HM) or low morbidity (LM) based on their recorded illnesses. HM was defined as the major complications associated with short-or long-term morbidity. Short-term morbidity included culture positive sepsis, pulmonary hemorrhage, pulmonary hypertension and acute hemodynamic instability. Long-term morbidity was defined by moderate or severe BPD, ROP Stage 2 or greater, grade 3 or 4 IVH, and NEC based on their significant association with adverse neurodevelopmental outcome. Death was also included. The majority of infants in the HM category had short-and long-term complications spanning multiple organ systems.

Infants having only common problems of prematurity such as mild respiratory distress syndrome (RDS) and patent ductus arteriosus without major complications were marked as LM. Five infants with a <2 day history of mechanical ventilation for RDS, but no other early complications, were transferred prior to ROP evaluation and were marked as LM.

### B. Example Probabilistic Score for Illness Severity

The example scoring system and methods estimate the probability that an infant would be in the HM category based on physiological signals recorded in the first 3 hours of life plus gestational age and birth weight. This time period was selected for analysis because it yields maximal sensitivity, is less likely to be confounded by medical interventions, and provides prediction early enough in the infant's life to impact therapeutic strategy.

First, the original physiological signals (heart rate, respiratory rate, oxygen saturation) that were recorded for each infant were processed. Mean values plus baseline and residual variability signals (capturing both short-and long-term variability) were calculated for heart and respiratory rate. Mean oxygen saturation and the ratio of hypoxia (e.g., oxygen saturation <85%) to normoxia over the 3 hour span was calculated.

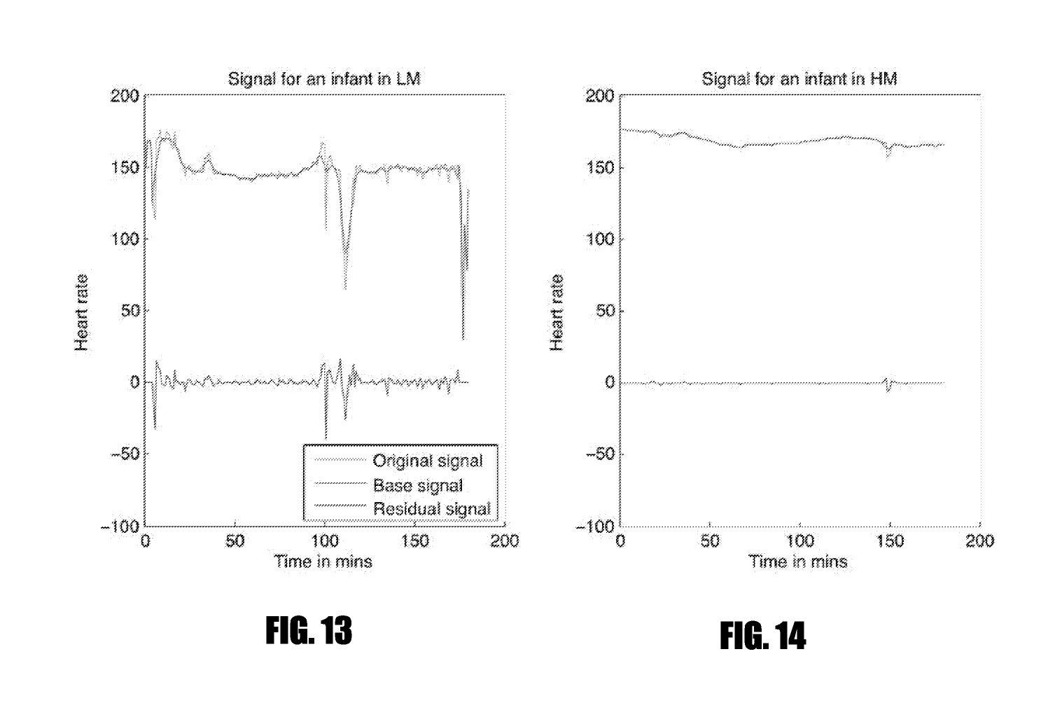

In some embodiments, time-series heart rate, respiratory rate and oxygen saturation data are collected from CR monitors. Heart rate (HR) and respiratory rate (RR) signals are processed using the original signal to compute a base and residual signal. The base signal represents a smoothed, long-term trend; it is computed using a moving average window of 10 minutes. The residual signal is obtained by taking the difference between the original signal and the base signal; it may characterize short-term variability most likely linked to sympathetic function (see FIGS. 13 and 14). For HR and RR, the base signal mean, base signal variance, and residual signal variance are computed. For the oxygen saturation, the mean and the ratio of the time the oxygen saturation is below 85% are computed.

Processing signal sub-components are shown in FIGS. 13 and 14. The sub-components show differing heart rate variability in two neonates matched for gestational age (29 weeks) and weight (1.15 kg±0.5 kg). Original and base signals are used to compute the residual signal. Differences in variability can be appreciated between the neonate predicted by the example scoring system to have HM (right) versus LM (left).

A probability for illness severity can be defined via a logistic function that aggregates individual risk features, as shown in Equation (1):

$$P ( HM \vert {v}_{1} , {v}_{2} , … , {v}_{n} ) = {( 1 + exp ( b + {w}_{0} * c + {\sum }_{i = 1}^{n} {w}_{i} * f ( {v}_{i} ) ) )}^{- 1} \qquad Equation ( 1 )$$

where n is the number of risk factors and c=log P(HM)/P(LM) is the a priori log-odds ratio. The i^{th} characteristic, vᵢ (physiological parameter, gestational age or weight) was used to derive a numerical risk feature f(vᵢ) via nonlinear Bayesian modeling. The score parameters b and w were learned from the training data sets for use in prospective risk prediction.

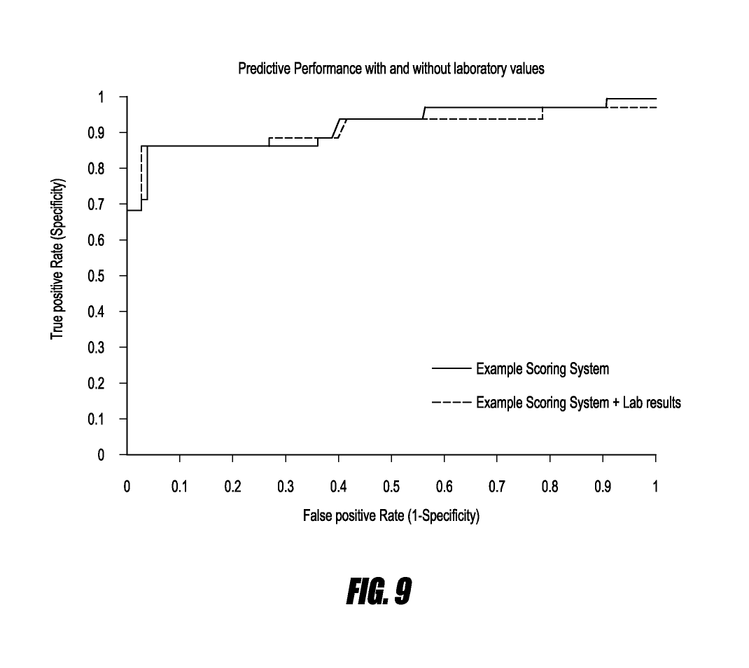

In an example embodiment, a total of 10 patient characteristics were used in calculations of the probabilistic score: heart rate mean, base and residual variability; respiratory rate mean, base and residual variability; oxygen saturation mean and cumulative hypoxia time; gestational age and birth weight. When laboratory values were added to determine the magnitude of their contribution to risk prediction beyond the example scoring system (see FIG. 9), values were incorporated that are included in standard risk prediction scores (e.g., SNAPPE II): white blood cell count, band neutrophils, hematocrit, platelet count and initial blood gas measurement of PaO₂, PaCO₂ and pH (if available at <3 hours of age).

Integration of continuous-valued features (e.g., physiological measurements) into the example risk model was achieved in this example using a Bayesian modeling paradigm that could capture the nonlinear relationships between each patient characteristic and the outcome. This Bayesian approach may have many possible advantages in certain applications, for example, it takes into account the fact that the overall behavior of a factor can vary greatly between sickness categories; it allows for missing data assumptions appropriate to specific classes of measurements; and/or it tolerates data scarcity without loss of predictive power.

To implement Equation (1), various embodiments of the present risk model integrate continuous-valued risk factors, including the physiological measurements, using various approaches. One possible approach is to define a “normal” range for a measurement, and use a binary indicator whenever the measurement is outside that range. While this approach can most easily be implemented in a clinical setting, it may, in some cases, provide relatively coarse-grained distinctions derived from extreme values. Another possible approach is to determine a particular representation of the continuous-valued measurement, usually either the feature itself, or a quadratic or logarithmic transformation, as selected, e.g., by an expert.

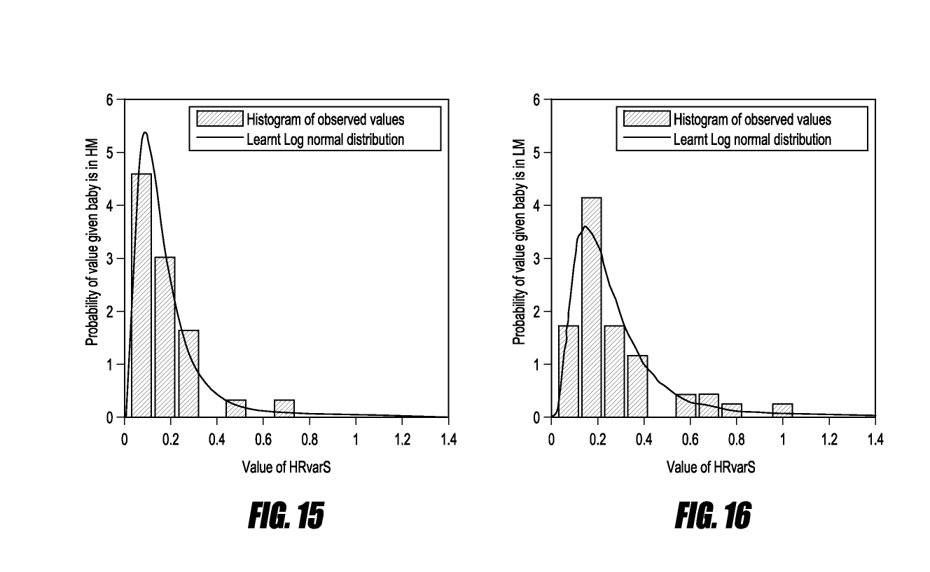

A different approach based on a Bayesian modeling paradigm is used in some embodiments. This approach can capture the nonlinear relationships between the risk factor and the outcome, and take into account the fact that the overall behavior of a factor can vary greatly between sickness categories. For each risk factor vᵢ, a parametric model of the distribution of observed values in the training set P(vᵢ|C) for each class of patients C (HM and LM) is separately learned. The parametric model is selected and learned using maximum-likelihood estimation (see FIGS. 15 and 16) from the set of long-tailed probability distributions of Exponential, Weibull, Log-Normal, Normal, and Gamma. Specifically, for each parametric class, the maximum likelihood parameters are fitted, and the parametric class that provides the best (highest likelihood) fit to the data is selected. The log-odds ratio of the risk imposed by each factor is incorporated into the model.

Examples of the distribution of residual heart rate variability (HRvarS) in the tested infants is shown in FIGS. 15 and 16. Learned parametric distributions are overlaid on the data distributions for HRvarS displayed for the HM versus LM categorization.

In the example scoring system, explicit missing data assumptions can be incorporated. When standard laboratory results (e.g., complete blood count) are not recorded, the analysis assumes that they are missing at random and not correlated with outcome. Their contribution if missing is 0 and log P(vᵢ|HM)/P(vᵢ|LM) otherwise. Blood gas measurements, however, are likely obtained only for profoundly ill patients and hence are not missing at random. Thus, for each measurement type i, mᵢ=1 if measurement vᵢ is missing and mᵢ=0 otherwise. The distribution P(mᵢ|C), the chance that the measurement i is missing for each patient category C, and P(vᵢ|C, mᵢ=0), the distribution of the observed measurements as described above, are now learned. The factor contribution for measurement i is computed as:

$$f ( {v}_{i} ) = \{ \begin{matrix}\frac{log P ( {v}_{i} \vert HM , {m}_{i} = 0 )}{P ( {v}_{i} \vert LM , {m}_{i} = 0 )} + \frac{log P ( {m}_{i} = 0 \vert HM )}{P ( {m}_{i} = 0 \vert LM )} & {m}_{i} = 0 \\ log P ( {m}_{i} = 1 \vert HM ) / P ( {m}_{i} = 1 \vert LM ) & {m}_{i} = 1\end{matrix}$$

In this example, this formulation may account both for the observed measurement, if present, and for the likelihood that a particular measurement might be taken for patients in different categories.

To control model complexity and prevent over-fitting of the training data, the example scoring system used regularization via a ridge penalty. To learn the score parameters b and w, the log likelihood of the data in the training set with a ridge penalty can be maximized as:

$${argmax}_{w , b} {\sum }_{j = 1}^{n} log P ( H \vert {v}_{1}^{j} , {v}_{2}^{j} … {v}_{18}^{j} ) - λ {\sum }_{i} {w}_{i}^{2}$$

The ridge penalty can help reduce spurious data dependence by enabling automatic factor selection to control model parsimony and prevents over-fitting. The hyper-parameter λ controls the complexity of the selected model and can be set to 1.2 or another value to achieve any desired result. In the example scoring system, the value of λ was selected using random 70/30 cross-validation splits, based on experimental analysis showing that the results were not sensitive to the choice of this parameter.

At least some embodiments provide one or more advantages. Putting morbidity risk factors in a probabilistic framework provides a comparable representation for different risk factors, allowing them to be placed within a single, integrated model. Utilizing a parametric representation of each continuous measurement alleviates issues arising from data scarcity. Uncovering the dependence between the risk factor and the illness category may automatically reduce data requirements by reducing or eliminating the need for cross-validation to select the appropriate form. In some methods, different parametric representations for patients in different categories, better capturing disease-induced changes in patient physiology, are utilized. In some embodiments, an interpretable visual summary of the likelihood of low patient morbidity over the range of values for each factor is obtained.

At least certain embodiments permit identification of a risk for illness severity at a substantially earlier stage of an infant's life than existing premature infant morbidity scoring systems. For example, in some embodiments, the monitoring period is less than or equal to about half the monitoring period of existing scoring systems. In certain embodiments, the monitoring period is less than or equal to about one quarter of the monitoring period of existing scoring systems. Some embodiments make use of continuous time-series data recorded during the monitoring period, unlike certain existing scoring systems, thereby producing a more accurate result. The combination of a relatively short monitoring period and a highly accurate result produces efficiencies in health care delivery and resource allocation, thereby generating substantial savings for hospitals and health care providers, improving patient outcomes, and saving lives.

Embodiments of the scoring systems disclosed herein can be applied to human or animal subjects. For example, subjects include not only preterm infants, but also infants born at full term, toddlers, children, teenagers, pediatrics, and adults (including geriatrics) who desire or require a health assessment. The systems and methods disclosed herein can also be used in veterinary applications. In addition, the scoring systems can be used to generate multiple or continually updated scores rather than a single score. For example, the monitoring period used to generate the risk factors can be a sliding window covering the immediate prior three hours or another suitable monitoring period. The score can be updated continuously, periodically, or intermittently as time passes, at least so long as measurements of physiological properties continue.

In certain embodiments, subjects who receive a score derived from the scoring systems and methods disclosed herein can be added to the model group after they are monitored or while they are monitored. Such subjects can be used to improve the score parameters. Subjects being monitored can be filtered so that only those subjects meeting certain demographic or other criteria are selected for addition to the model group. Hospitals and other health care providers can connect to a pool of other hospitals or health care providers to share model group data, resulting in a much larger model group. A larger model group can be used to generate improved and/or more tailored score parameters.

In some embodiments, a morbidity score is used to determine when a preterm infant can be released from a NICU. A morbidity score can also be used to determine when a healthy-looking baby needs to remain in the NICU or in a health care institution because of a probability of high morbidity that is not apparent from observational data. A morbidity score can be used to determine a treatment course for a preterm infant. For example, the morbidity score can be used to determine whether the infant should receive medication, a surgical procedure, breathing assistance, another medical procedure, or a combination of procedures. In certain embodiments, a morbidity score is used for a diagnosis. In some embodiments, the morbidity score can be used to determine factors that contribute to illness that were previously unknown.

### C. Evaluation of Example Scoring System

To assist evaluating the example scoring system, the leave-one-out method was used. Using this method, predictive accuracy was evaluated for each patient separately. For each patient, the model parameters were learned using the data from the other patients as the training set, and evaluated predictive accuracy on the held out patient. This technique was repeated for each subject, so that each subject's clinical data was prospectively obtained. This method of performance evaluation is computationally intensive but suitable for measuring performance when the sample set size is relatively small. In other embodiments, other statistical methods can be used to evaluate the performance of the scoring system.

Receiver-operating-characteristic (ROC) curves were plotted for the example scoring system, the example scoring system plus laboratory values, and for certain existing risk scores, calculated as described in literature for SNAP-II, SNAPPE-II, CRIB. Sensitivity, specificity, area under the curve (AUC), and significance values were computed for each comparison.

The baseline characteristics and morbidities of the example study population are shown in Table A.

TABLE A
Baseline and Disease Characteristics of the Study Cohort.

| | |
|---|---|
| N | 138 |
| Birth weight, g | 1367 ± 440 |
| Gestational age, wk | 29.8 ± 3 |
| Gender, female | 68 |
| Apgar Score at 5 min | 7 ± 3 |
| SGA (≦5th percentile) | 7 |
| Multiple Gestation | 46 |
| Twins | 20 |
| Triplets | 6 |
| Respiratory distress syndrome | 112 |
| Pneumothorax | 10 |
| Bronchopulmonary dysplasia | 29 |
| Not otherwise specified* | 2 |
| Mild | 12 |
| Moderate | 5 |
| Severe | 10 |
| Pulmonary hemorrhage | 2 |
| Pulmonary hypertension | 3 |
| Acute hemodynamic instability | 11 |
| Retinopathy of Prematurity† | 25 |
| Stage I | 9 |
| Stage II | 12 |
| Stage III | 4 |
| Intraventricular hemorrhage‡ | 34 |
| Grade 1 | 19 |
| Grade 2 | 7 |
| Grade 3 | 3 |
| Grade 4 | 5 |
| Post hemorrhagic hydrocephalus | 6 |
| Culture positive sepsis | 11 |
| Necrotizing enterocolitis | 8 |
| Stage 1 | 2 |
| Stage 2 | 4 |
| Stage 3 | 2 |
| Expired | 4 |

*Infants with oxygen requirement at 28 days for whom oxygen requirement was not known at 36 weeks post menstrual age.
†ROP is counted by the most severe stage in either eye during the hospitalization.
‡IVH is counted by the most severe grade in either cerebral hemisphere.

A total of 138 preterm neonates ≦34 weeks and 2000 grams without major congenital malformations were included. Mean birth weight was 1367 g at an estimated gestational age of 29.8 weeks. Average 5-minute Apgar score was 7, suggesting a relatively low risk population despite prematurity. Thirty-five neonates had the high morbidity (HM) complications. Of these, thirty-two had long-term morbidities (moderate or severe BPD, ROP Stage 2 or greater, grade 3 or 4 IVH, and/or NEC). Four neonates died after the first 24 hours of life. There were 103 preterm neonates with only common problems of prematurity (RDS and/or PDA). These 103 neonates were considered low morbidity (LM).

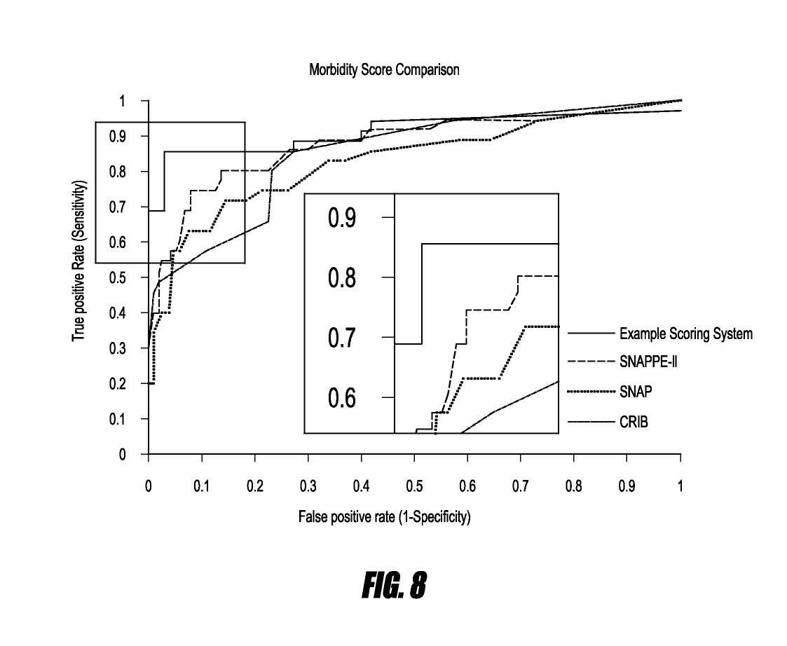

The example scoring system's discriminative ability for prediction of high morbidity and mortality risk, according to an embodiment, was demonstrated by plotting the receiver operating characteristic curve (ROC) (see FIG. 8).

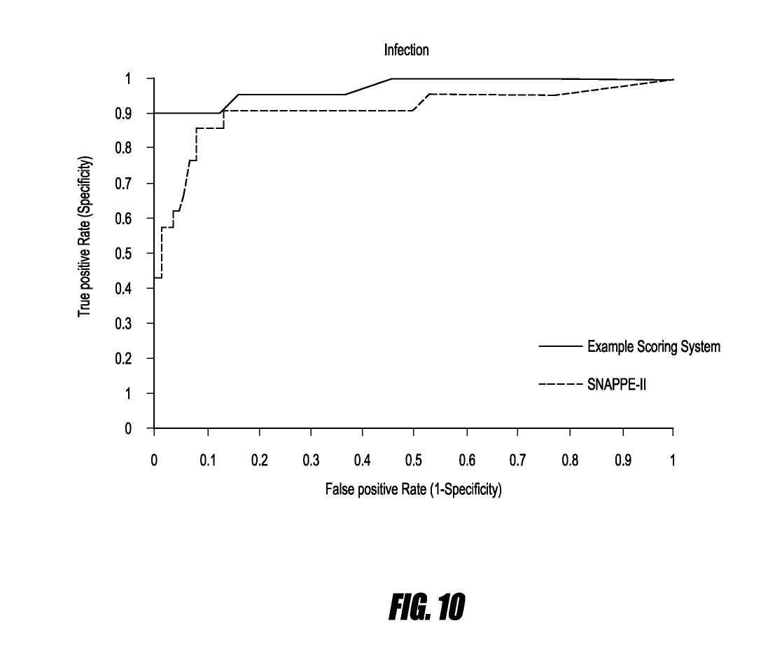

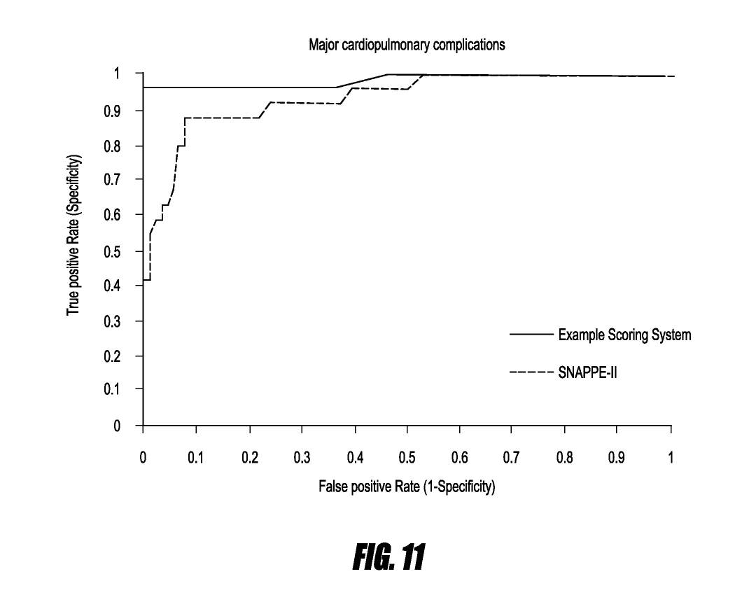

FIGS. 8-11 are receiver operating characteristic curves demonstrating the example scoring system's performance as it relates to: conventional scoring systems (FIG. 8), to the example scoring system and laboratory studies (FIG. 9), predicting infection related complications (FIG. 10), and predicting major cardiopulmonary complications (FIG. 11).

In some embodiments, the example scoring system generates a probability score that ranges between 0 and 1, with higher probability scores indicating higher morbidity. By setting a user-defined threshold based on desired sensitivity and specificity, a scoring system can be optimized for a particularized clinical setting. For example, a threshold of 0.5 achieved sensitivity of 86% at specificity of 95% for HM in the study population. Other thresholds can be set depending on individualized situations. Thresholds can be set or updated by, for example, a physician, a hospital or NICU, or by the system.

The example scoring system was compared to extensively validated neonatal scoring systems (SNAP-II, SNAPPE-II, and CRIB). Comparative discriminative ability of these scores is shown by the ROC curves (FIG. 8) and associated area-under-the-curve (AUC) values (Table B).

The example scoring system (AUC 0.9197) performs well across the entire range of the ROC curve and significantly better (p=0.003) than the three comparison scores (Table B). It achieves the largest performance gain in the high sensitivity/specificity region of the curve (FIG. 8). When laboratory measurements were added to the example scoring system (FIG. 9), little or no discriminatory gain was achieved, suggesting that laboratory information may be largely redundant with the patient's physiologic characteristics, at least for this example scoring system applied to the example study data.

TABLE B
Performance summary using AUCs.

| | | | | Example |
|---|---|---|---|---|
| | SNAP-II | SNAPPE-II | CRIB | scoring system |
| Predicting High | 0.8298 | 0.8795 | 0.8509 | 0.9151 |
| Morbidity | | | | |
| Infection | 0.8428 | 0.9087 | 0.8956 | 0.9733 |
| Heart/Lung | 0.8592 | 0.9336 | 0.9139 | 0.9828 |

To assess performance for prediction of specific morbidities contained in the HM categorization, two categories were extracted: infection—NEC, culture positive sepsis, urinary tract infection, pneumonia (FIG. 10) and cardiopulmonary complications—BPD, hemodynamic instability, pulmonary hypertension, pulmonary hemorrhage (FIG. 11). Plotting the HM category infants with a specific complication against the infants in the LM category yields ROC curves for discriminative ability for these independent morbidity categories (FIGS. 10 and 11). Comparison to SNAPPE-II (the best performing standard score) is also shown; AUCs were calculated for the example scoring method and comparative scoring methods (Table B) in these specifically defined sets of morbidity. Using a threshold of 0.5, the example scoring system achieves excellent performance (e.g., infection: 90% sensitivity at 100% specificity, cardiopulmonary: 96% at 100%).

Ablation analysis—comparison of model performance when different subsets of risk factors are included—was used to examine the contribution of score subcomponents. Gestation and birth weight can contribute greatly to model success (e.g., AUC 0.8517). However, these characteristics alone may not be sufficient for individual risk prediction, in some cases. Physiological parameters alone may contribute more than laboratory values (e.g., AUC 0.8540 versus 0.7710, respectively). Adding physiological parameters to gestation and birth weight (e.g., using the example scoring system) can increase the AUC to 0.9129, significantly (p<0.01) better than gestation and birth weight alone. Addition of laboratory values and physiologic characteristics did not increase the AUC (e.g., AUC 0.9197) in this example, again suggesting that the latter may be redundant with the laboratory data in morbidity prediction in some cases.

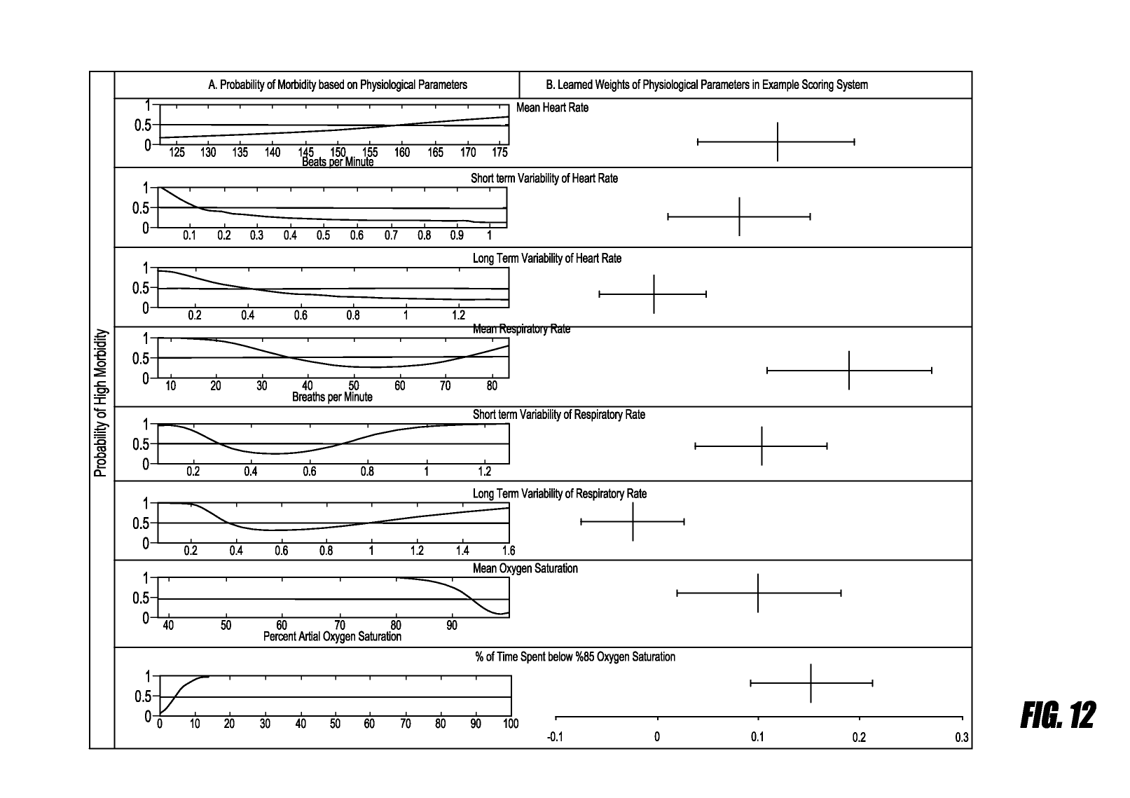

The probability of High Morbidity classification as expressed by a non-linear function and the learned weight for each physiological parameter incorporated in the example scoring system is shown in FIG. 12. The learned weights shown on the right hand side of FIG. 12 are located at the end of each of the bars, which begin at zero. The error bars around each learned weight show a range of uncertainty in each learned weight.

In some embodiments, a scoring system uses three categories of commonly obtained physiological measurements: heart rate, respiratory rate and oxygen saturation. In other embodiments, additional or different categories of measurements can be used such as, e.g., blood pressure (systolic and/or diastolic), expired carbon dioxide, blood glucose, lactate, etc. From these measures, individual curves are obtained that convey the probability of high morbidity associated with individually calculated physiological parameters (see FIG. 12). A respiratory rate between 35 and 75 breaths per minute had a greater probability of being associated with health, while higher or lower rates carried a greater probability of morbidity. Decreased short-term heart rate variability also indicated increased risk.

This analysis also found that short-term respiratory rate variability, not commonly used as a physiological marker, was associated with increased morbidity risk. Unlike residual heart rate variability, its effect was non-monotonic. Risk curves describing oxygen saturation suggest, respectively, that risk increases significantly with mean saturations less than 92% and prolonged time spent (e.g., >5% total time) at oxygen saturations below 85%. Oxygenation is routinely manipulated by physician intervention, suggesting that intervention failure (e.g., the inability to keep saturations in a specific range) that allows desaturations lasting for >5% of total time will be associated with higher morbidity risk, a threshold that can now be prospectively assessed in clinical trials.

The learned weights of the individual parameters incorporated into the model (see FIG. 12) are also informative regarding risk and could reveal links in pathophysiology underlying morbidities. Both short-term heart and respiratory rate variability contribute greatly, but long-term variability does not weigh heavily in some embodiments of the example scoring system.

Some embodiments provide a risk stratification method that predicts morbidity for individual preterm neonates by integrating multiple continuous physiological signals from the first three hours of life. The example scoring system and methods provided consistently better discriminative accuracy for high morbidity than SNAP-II, SNAPPE-II, and CRIB, as evidenced by significant increases in AUC values (Table B).

For each score, the majority of this discriminative ability comes from gestational age and birth weight, but age and weight matched neonates may have significantly different morbidity profiles. To individualize prediction, CRIB adds malformations, inspired oxygen need and base excess, SNAP-II and SNAPPE-II add several thresholded physiological measures, and SNAPPE-II includes 5-minute Apgar score; however, none discriminate morbidity risk as well as the example scoring system and methods, which can integrate a small set of substantially continuous physiological measures calculated directly from commonly used monitoring devices.

The example scoring system can provide high accuracy predictions about morbidity risk, even when such outcomes manifest days or weeks later (e.g. BPD or NEC). Identification of a patient's initial risk of developing high morbidity has value for medical resource allocation such as transport to a higher level of care and nurse staffing ratios. The example scoring system's ability to assess physiologic disturbances before it can be confounded by medical intervention makes it particularly descriptive of initial patient acuity; thus, it is particularly well suited as a tool for quality assessment between NICUs. When implemented in a bedside monitor, at least some embodiments can indicate the statistical likelihood that an individual is at high risk of major morbidities, allowing real-time use of the example scoring system calculation.

At least some embodiments can be used in ways that fetal heart rate monitoring is used. For example, loss of short-term heart rate variability can predict fetal or newborn distress and guide health care decisions. Although the precise source of variability loss (either pre- or post-natally) is unknown, autonomic dysregulation may play a role.

Unlike fetal heart rate monitoring or heart rate spectral analysis in the neonate, at least some embodiments use multiple physiological responses to improve accuracy and provide long-term predictions that extend beyond acute risk. Unlike biomarkers, such predictions are made with data that is already being collected in NICUs.

Patient oxygenation, heart and respiratory rates can be automatically processed to compute a score, and a sensitivity and/or specificity threshold can be used to make morbidity predictions to guide clinical actions, thereby reducing the need for end-user expertise. At least some embodiments may be particularly useful for decision-making in primary nurseries to make more informed decisions regarding aggressive use of intensive care, need for transport to higher levels of care and resource allocation. Certain embodiments provide economic, social and medical advantages, because they may provide an earlier and more accurate predictive indicator of morbidity than at least some existing scoring systems. An early and accurate predictive morbidity indicator can allow more efficient allocation of health care resources, thereby lowering costs, improving outcomes, and even saving lives.

The performance results of the example scoring system as presented herein were established using a relatively small sample size. Analysis methods appropriate to small sample sizes were used and ROC curves were made for at least some morbidities seen in greater than ten percent of the population. The model used herein with automatic factor modeling and selection may use relatively little or no parameter tuning, which may help prevent over fitting in small samples. Also, the sample considered herein is from a single, tertiary care center and was limited to an inborn cohort to ensure that continuous physiological data was available for the first hours of life.

Some embodiments use computer-based techniques to integrate and interpret patterns in patient data to automate morbidity prediction. The current governmental mandate to improve electronic health record use and gain economic benefit from using digital data makes this an opportune time to develop new, easy to implement computer-based tools that can access electronic health records. The use of flexible Bayesian modeling with few, almost no, or no tunable parameters allows at least some embodiments to be applied to a range of different prediction tasks.

At least some embodiments can be applied with different combinations of risk factors, including some that are observed only in a subset of patients. Other embodiments can be applied more broadly to other intensive care populations where data is continuously being recorded.

In general, the word “module,” as used herein, is used in its broad and ordinary sense and refers, for example, to logic embodied in hardware or firmware, or to a collection of software instructions, possibly having entry and exit points, written in a programming language, such as, for example, Java, C or C++. A software module may be compiled and linked into an executable program, installed in a dynamic link library, or may be written in an interpreted programming language such as, for example, BASIC, Perl, or Python. It will be appreciated that software modules may be callable from other modules or from themselves, and/or may be invoked in response to detected events or interrupts. Software instructions may be embedded in firmware, such as an EPROM. It will be further appreciated that hardware modules may be comprised of connected logic units, such as gates and flip-flops, and/or may be comprised of programmable units, such as programmable gate arrays, application-specific circuits, or hardware processors. The modules described herein are preferably implemented as software modules, but may be represented in hardware or firmware. Generally, the modules described herein refer to logical modules that may be combined with other modules or divided into sub-modules despite their physical organization or storage.

The various illustrative logical blocks, modules, data structures, algorithms, equations, and processes described herein may be implemented as electronic hardware, computer software, or combinations of both. To clearly illustrate this interchangeability of hardware and software, various illustrative components, blocks, modules, and states have been described above generally in terms of their functionality. However, while the various modules are illustrated separately, they may share some or all of the same underlying logic or code. Certain of the logical blocks, modules, and processes described herein may instead be implemented monolithically.

The various illustrative logical blocks, modules, data structures, and processes described herein may be implemented or performed by a machine, such as a computer, a processor, a digital signal processor (DSP), an application specific integrated circuit (ASIC), a filed programmable gate array (FPGA) or other programmable logic device, discrete gate or transistor logic, discrete hardware components, or any combination thereof designed to perform the functions described herein. A processor may be a microprocessor, a controller, a microcontroller, a state machine, combinations of the same, or the like. A processor may also be implemented as a combination of computing devices—for example, a combination of a DSP and a microprocessor, a plurality of microprocessors or processor cores, one or more graphics or stream processors, one or more microprocessors in conjunction with a DSP, or any other such configuration.

The blocks or states of the processes described herein may be embodied directly in hardware or firmware, in a software module executed by a hardware processor, or in a combination of the two. For example, each of the processes described above may also be embodied in, and fully automated by, software modules executed by one or more machines such as computers or computer processors. A module may reside in a non-transitory computer-readable storage medium such as RAM memory, flash memory, ROM memory, EPROM memory, EEPROM memory, registers, a hard disk, a removable disk, a CD-ROM, a DVD, memory capable of storing firmware, or any other form of computer-readable storage medium. An exemplary computer-readable storage medium can be coupled to a processor such that the processor can read information from, and write information to, the computer readable storage medium. In the alternative, the computer-readable storage medium may be integral to the processor. The processor and the computer-readable storage medium may reside in an ASIC. Hardware components may communicate with other components via wired or wireless communication networks such as, e.g., the Internet, a wide area network, a local area network, or some other type of network.

Depending on the embodiment, certain acts, events, or functions of any of the processes or algorithms described herein can be performed in a different sequence, may be added, merged, or left out altogether. Thus, in certain embodiments, not all described acts or events are necessary for the practice of the processes. Moreover, in certain embodiments, acts or events may be performed concurrently, e.g., through multi-threaded processing, interrupt processing, or via multiple processors or processor cores, rather than sequentially.

Conditional language used herein, such as, among others, “can,” “could,” “might,” “may,” “e.g.,” and the like, unless specifically stated otherwise, or otherwise understood within the context as used, is intended in its ordinary sense and is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous, are used in their ordinary sense, and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. Conjunctive language such as the phrase “at least one of X, Y and Z,” unless specifically stated otherwise, is understood with the context as used in general to convey that an item, term, element, etc. may be either X, Y or Z. Thus, such conjunctive language is not generally intended to imply that certain embodiments require at least one of X, at least one of Y and at least one of Z to each be present.

It should be appreciated that in the above description of embodiments, various features are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that any claim require more features than are expressly recited in that claim. Moreover, any components, features, or steps illustrated and/or described in a particular embodiment herein can be applied to or used with any other embodiment(s). Further, no component, feature, step, or group of components, features, or steps are necessary or indispensable for each embodiment. Thus, it is intended that the scope of the inventions herein disclosed and claimed below should not be limited by the particular embodiments described above, but should be determined only by a fair reading of the claims that follow.

What is claimed is:

1. A method for predicting morbidity of a premature infant using at least two noninvasive physiological properties, the method comprising:
accessing from a computer storage medium a gestational age and a birth weight of the premature infant;
accessing from a computer storage medium substantially continuous time-series data for two noninvasive physiological properties of the premature infant during a monitoring period of between about one hour and about ten hours, wherein the time-series data is collected without substantial human intervention during the monitoring period;
computing a stable value and a characterization of dynamics of the time-series data for at least one of the two physiological properties;
determining, via execution of instructions on computer hardware, a morbidity risk factor for: (1) the gestational age of the premature infant, (2) the birth weight of the premature infant, and (3) each of the stable values and the characterizations of dynamics;
weighting each of the morbidity risk factors using weightings learned from an optimization procedure optimized on a model group of premature infants;
aggregating each of the weighted morbidity risk factors to generate a predictive indicator of morbidity of the premature infant; and
outputting the predictive indicator to a front end module.

2. The method of claim 1, wherein the two physiological properties comprise a heart rate of the infant and a respiratory rate of the infant.

3. The method of claim 1, further comprising accessing from a computer storage medium substantially continuous time-series data for at least a third physiological property.

4. The method of claim 3, wherein the at least a third physiological property comprises oxygen saturation of the premature infant.

5. The method of claim 1, wherein determining a morbidity risk factor for each of the stable values and the characterizations of dynamics comprises comparing the stable values and the characterizations to a nonlinear probability function.

6. The method of claim 1, wherein the stable value of the time-series data is the mean.

7. The method of claim 1, wherein the characterization of dynamics of the time-series data is the variance.

8. The method of claim 1, wherein computing a stable value and a characterization of dynamics of the time-series data for at least one of the two physiological properties comprises:
receiving original time-series physiological data;
computing a base signal by time-averaging the original physiological data;
computing a residual signal by calculating a difference between the base signal and the original signal; and
computing the variance of the base signal and the residual signal.

9. The method of claim 8, further comprising computing the mean of the base signal.

10. The method of claim 8, wherein computing a base signal by time-averaging the original physiological data comprises computing the base signal using a moving average window of 10 minutes.

11. The method of any of claim 1, further comprising:
accessing from a computer storage medium substantially continuous time-series data for at least a third physiological property of the premature infant collected during the monitoring period; and
computing a mean of the time-series data for the third physiological property.

12. The method of claim 11, further comprising computing a ratio between a period of time when the third physiological property is below a threshold level and the monitoring period.

13. The method of claim 12, further comprising determining a morbidity risk factor indicated by the ratio.

14. The method of claim 1, further comprising accessing from a computer storage medium data collected using at least one invasive measurement of the premature infant.

15. The method of claim 1, further comprising using the predictive indicator and at least one other medical score to assess the physical well-being of the premature infant.

16. A system for predicting morbidity of a subject using at least two noninvasive physiological properties, the system comprising:
a front end module configured to provide a user interface for communicating a morbidity prediction to a health care provider;
physical computer storage configured to store a gestational age and a birth weight of the subject, and substantially continuous time-series data for two noninvasive physiological properties of the subject during a monitoring period greater than or equal to about one hour; and
a hardware processor in communication with the physical computer storage, the hardware processor configured to execute instructions configured to cause the hardware processor to:
access from the physical computer storage the gestational age and the birth weight of the subject;
access from the physical computer storage the substantially continuous time-series data for at least two noninvasive physiological properties of the subject during a monitoring period greater than or equal to about one hour;
compute one or more characterizations of the time-series data for each of the at least two noninvasive physiological properties;
determine a morbidity risk factor for the gestational age, for the birth weight, and for each of the one or more characterizations of the time-series data;
weight each morbidity risk factor using weightings learned from an optimization procedure optimized on a sample population;
aggregate each of the weighted morbidity risk factors to generate a predictive indicator of morbidity of the premature infant; and
output the predictive indicator to the front end module.

17. The system of claim 16, wherein the subject is a premature infant.

18. The system of claim 17, wherein the sample population is a model group of premature infants.

19. The system of claim 16, wherein the time-series data for the at least two noninvasive physiological properties is collected without substantial human intervention during the monitoring period.

20. The system of any of claim 16, wherein the monitoring period is greater than or equal to about 3 hours.

21. The system of claim 20, wherein the monitoring period is less than or equal to about 24 hours.

22. A method for creating a scoring system for a probability for illness severity of a subject using at least two noninvasive physiological properties, the method comprising:
accessing from a computer storage medium observational data associated with each member of a model group;
accessing from a computer storage medium substantially continuous time-series data for at least two noninvasive physiological properties of each member of the model group collected during a monitoring period greater than or equal to about one hour;
computing observed values for each of the at least two physiological properties, wherein the observed values for the at least two physiological properties comprise one or more characterizations of the time-series data;
dividing the model group into two or more sickness categories;
selecting a probability distribution for the observed values in each of the two or more sickness categories of the model group by using a maximum-likelihood estimation on a set of long-tailed probability distributions, wherein each selected probability distribution provides a best fit to the observed values for the subjects in each of the two or more sickness categories;
determining, via execution of instructions on computer hardware, a numerical risk feature for each observed value based on the selected probability distribution for the observed values in each of the two or more sickness categories; and
determining, via execution of instructions on computer hardware, a set of score parameters comprising a weighting for each of the numerical risk features.

23. The method of claim 22, further comprising:
accessing from a computer storage medium substantially continuous time-series data for at least a third noninvasive physiological property of each member of the model group collected during the monitoring period; and
computing at least one observed value from the time-series data for the third noninvasive physiological property, wherein the at least one observed value comprises a stable value of the time-series data for the at least a third noninvasive physiological property.

24. The method of claim 22, wherein determining the score parameters comprises maximizing the log likelihood of the observed values in the model group with a ridge penalty.

25. The method of claims 22, wherein the subject is a premature infant.

26. The method of claim 22, wherein the members of the model group are selected from a geographical region surrounding an institution wherein the subject will receive treatment.

27. The method of claim 22, wherein the set of long-tailed probability distributions comprises at least one of an Exponential, Weibull, Log-Normal, Normal, or Gamma distribution.

28. The method of claim 22, wherein the observed values comprise a mean, a residual, or a mean and a residual.

29. The method of claim 22, wherein a probability P for illness severity of a subject is determined, via execution of instructions on computer hardware, using a logistic function to aggregate numerical risk features f(vᵢ):
$$P ( HM \vert {v}_{1} , {v}_{2} , … , {v}_{n} ) = {( 1 + exp ( b + {w}_{0} * c + {\sum }_{i = 1}^{n} {w}_{i} * f ( {v}_{i} ) ) )}^{- 1} ,$$
wherein n is the number of numerical risk features, c is an a priori log-odds ratio, and b and w are score parameters learned from the model group for use in prospective risk prediction.
